(19) United States
(12) Patent Application Publication
(10) Pub. No.: US 2020/0195564 A1
(43) Pub. Date: Jun. 18, 2020

(54) DATA TRANSMISSION BOOSTING DEVICE

(71) Applicant: FORGAMERS INC., Taipei City (TW)

(72) Inventors: Chih-Jen HUANG, Taipei City (TW); Yu-Hsiang WU, Taipei City (TW); Yi-Xuan LU, Taipei City (TW)

(21) Appl. No.: 16/400,970

(22) Filed: May 1, 2019

(30) Foreign Application Priority Data
Dec. 14, 2018 (TW) 107145240

(51) Int. Cl. H04L 12/851; H04L 12/803; H04L 12/721; G06N 20/00; H04L 12/751; H04L 12/725; H04L 12/727

(52) U.S. Cl. CPC H04L 47/2441; H04L 47/122; H04L 45/38; H04L 45/121; H04L 45/08; H04L 45/306; G06N 20/00

(57) ABSTRACT

A data transmission boosting device which can receive a plurality of data packets generated by terminal devices and connect to the router. The data transmission boosting device includes a classifying module which stores a classifying model, and the classifying model includes a plurality of classifying features. The classifying module can classify the type of each data packets by the classifying model and the packet information of data packets. The data transmission boosting device transmits the data packets classified as the data packets for boosting to the boosting server through the router. The data transmission boosting device of the present invention not only can improve the transmission efficient by the classifying module, but also can save the network flow cost.

### CROSS-REFERENCE TO RELATED APPLICATIONS

This application claims the priority benefit of Taiwan Application No. 107145240, filed on Dec. 14, 2018, the disclosure of which is incorporated herein by reference.

### BACKGROUND OF THE INVENTION

### 1. Field of the Invention

The present invention relates to a data transmission boosting device, more particularly, to a data transmission boosting device can precisely and automatically classify the data packets as packets for boosting.

### 2. Description of the Prior Art

In this age of fast network communication and convenient data transmission, people gradually rely on the internet. The business transactions, interpersonal interactions or lifestyles of people are closely related to the internet. People use mobile phones, computers, or other terminal devices to receive or transmit the messages or information by the network, and the data packets are the smallest unit of information that can be transmitted on the network. The data packet includes a header and a payload. The data packet transmission means that a sending terminal device generates a data packet with content and sends it to a router, and then the router transmits the data packet to a receiver of the terminal device according to the network address of the data packet. Finally, the terminal device restores the data packet to the content. Since the network includes many different types of terminal devices, communication protocols are required between each terminal device to transmit data, such as TCP/IP/HTTP. According to the Open System Interconnection Reference Mode (OSI) published by the International Organization for Standardization (ISO), a communication protocol is used to regulate the data communication of computer networks or other networks. The OSI includes into seven layers, and the third layer of OSI is used to plan the combination of the data packets and the transmission path. Therefore, the data can be transmitted between the terminal devices through the network.

In this high-efficient society, the data transmission speed is an important factors for the efficiency. Due to the rapid development of the internet and the popularity of the global information network and multimedia, the amount of data has increased significantly, and the growth of network transmission speed cannot catch the growth of network data. In order to solve the situation of network traffic jam caused by transferring a large amount of data, the network boosting server is most commonly used to increase the data transmission speed. The data packets generated by the sending terminal device are transmitted to the boosting server, and the boosting server transmits the data packets through an optimal route arranged by the boosting server to achieve network boosting. The boosting servers are typically used for the devices or applications requiring low latency network, such as games with network capabilities. Online games require instant communication with other players around the world. Compared to other types of devices and applications, if the network speed is not fast, it may hurt the player's gaming experience. If the data packets transmitted by an application or device that do not require low-latency network are transmitted to the boosting server, the boosting process of the application or device that should be boosted might be delay.

In addition, if all of the data packets are transmitted to the boosting server without restriction, it will cause many problems, such as the increase of the traffic cost, the low boosting efficiency for the packets for boosting caused by the irrelevant transmission flow, the low boosting efficiency for the packets for boosting caused by boosting all kinds of data packets, and the like. Therefore, if the boosting mechanism is not properly managed, it will cause unnecessary waste on the boosting devices and network resources. More importantly, it will also reduce the advantage of the boosting mechanism applied to network boosting to form another network traffic jam.

In order to avoid unrestricted transmitting of data packets to the booster, software type boosters and hardware type boosters have been developed to boost the specific data packets in the prior art. The software type booster is a terminal device that is installed on the sending terminal by a software such as WTFast, which boosts the flow generated by executing the game program according to monitoring the execution procedure of the game program on the Windows operating system of the computer. In the software type booster, it is necessary to clearly define the game program, and the user can use the program in the computer to define the game program to boost its data packets. The hardware type booster can be connected between the terminal devices to identify the game data packets by manually collecting the information of the game data packet such as the IP address, and then boost the packet including the IP address. However, the above hardware type booster still requires the user or the manufacturer to define an application or device that needs to be boosted to determine whether it is a data packet to be boosted. If a new device or application is added in the future, the hardware type booster cannot classify the new type of data packet by itself. It is inconvenient for the users.

Therefore, it is necessary to develop a device that can precisely classify the packet for boosting, and can automatically classify whether the new type of data packet is a data packet for boosting to solve the above problem.

### SUMMARY OF THE INVENTION

One aspect of the present invention is to provide a data transmission boosting device to solve the problems of the prior art.

According to one embodiment of the present invention, the data transmission boosting device can be connected to a router and at least one terminal device, and can receive a plurality of data packets generated by the at least one terminal device. The router is connected to a boosting server. The data transmission boosting device includes a classifying module for storing a classifying model, and the classifying model includes a plurality of classifying features. The classifying module respectively classifies each of the data packets as one of data packet for boosting, non-boosting data packet and unknown data packet according to the classifying model and a plurality of packet information of the data packets. Wherein, the data transmission boosting device transmits the data packets classified as the data packets for boosting to the boosting server through the router.

In one embodiment, the data packet for boosting is a game data packet.

In one embodiment, the data transmission boosting device transmits the data packets classified as the non-boosting data packets to a network through the router.

In one embodiment, the data transmission boosting device further includes a learning module connected to the classifying module. The learning module analyzes the data packets classified as the unknown data packets by machine learning to obtain the classifying features of the unknown data packets, and transmits the classifying features back to the classifying module to update the classifying model.

In one embodiment, the data transmission boosting device further includes a sorting module connected to the classifying module. The sorting module counts a ratio of the number of the data packets generated by the at least one terminal device which is corresponding to the data packets classified as the data packets for boosting, and sorts the priorities for transmitting the data packets generated by the at least one terminal device to the boosting server according to the ratio of the number of the data packets.

Another one aspect of the present invention is to provide a method for boosting the data transmission which including the following steps: receiving a plurality of data packets generated by at least one terminal device; classifying the data packets as one of data packet for boosting, non-boosting data packet and unknown data packet according to a packet information of the data packets by a classifying model respectively, and the classifying model including a plurality of classifying features; and transmitting the data packets classified as the data packets for boosting to a boosting server.

Wherein, the method for boosting the data transmission further includes the following step: transmitting the data packets classified as the non-boosting data packets to a network.

In one embodiment, the method for boosting the data transmission further includes the following step: obtaining the classifying features of the unknown data packets by machine learning for the data packets classified as the unknown data packets, and updating the classifying model by the classifying features.

In one embodiment, the method of data transmission boosting further includes the following steps: counting a ratio of the number of the data packets generated by the at least one terminal device which is corresponding to the data packets classified as the data packets for boosting; and sorting the priorities for transmitting the data packets generated by the at least one terminal device to the boosting server according to the ratio of the number of the data packets.

Another aspect of the present invention is to provide a router which including a routing module and a classifying module. The router is connected to at least one terminal device and a boosting server, and receives a plurality of data packets generated by the at least one terminal device. The classifying module is connected to the router and stores a classifying model, and the classifying model includes a plurality of classifying features. The classifying module respectively classifies each of the data packets as one of data packet for boosting, non-boosting data packet and unknown data packet according to the classifying model and a plurality of packet information of the data packets. Moreover, the router transmits the data packets determined as the data packets for boosting to the boosting server.

In one embodiment, the router transmits the data packets classified as the non-boosting data packets to a network.

In one embodiment, the router further includes a learning module connected to the classifying module. The learning module analyzes the data packets classified as the unknown data packets by machine learning to obtain the classifying features of the unknown data packets, and transmits the classifying features back to the classifying module to update the classifying model.

In one embodiment, the router further includes a sorting module connected to the classifying module. The sorting module counts a ratio of the number of the data packets by the data packets generated by the at least one terminal device which is corresponding to the data packets classified as the data packets for boosting, and sorting the priorities for transmitting the data packets generated by the at least one terminal device to the boosting server according to the ratio of the number of the data packets

The data transmission boosting device of the present invention automatically classifies the data packets generated by the terminal device as the data packets for boosting to the boosting server by the classifying module and transmits them to the boosting server. The data transmission boosting device arranges the priorities to transmit the data packets for boosting to the boosting server by the sorting module according to the ratio of the number of the packets. The data transmission boosting device not only can improve the transmission efficient, but also can save the network flow cost.

### BRIEF DESCRIPTION OF THE APPENDED DRAWINGS

FIG. 1 is a functional block drawing illustrating the data transmission boosting device according to one embodiment of the present invention.

FIG. 2 is a flow chart diagram illustrating the method of data transmission boosting according to one embodiment of the present invention.

FIG. 3 is a flow chart diagram illustrating the method of data transmission boosting according to one embodiment of the present invention.

FIG. 4 is a flow chart diagram illustrating the method of data transmission boosting according to one embodiment of the present invention.

FIG. 5 is a functional block drawing illustrating the router according to one embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

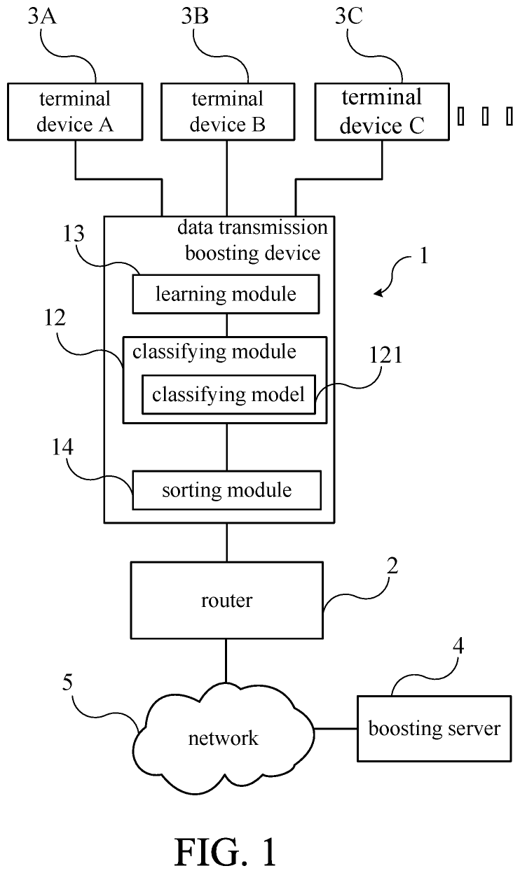

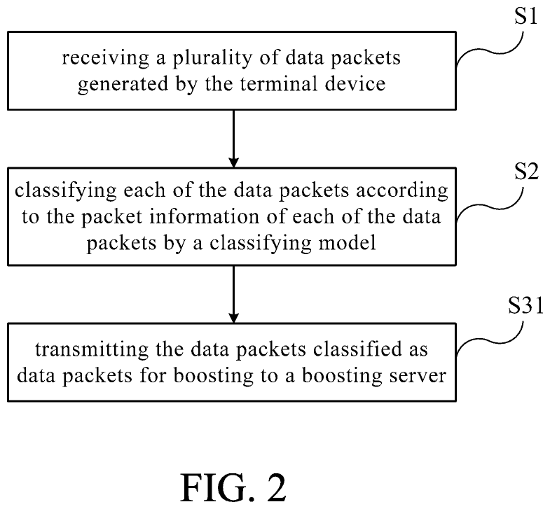

Please refer to FIG. 1 and FIG. 2. FIG. 1 is a functional block drawing illustrating the data transmission boosting device 1 according to one embodiment of the present invention. FIG. 2 is a flow chart diagram illustrating the method of data transmission boosting according to one embodiment of the present invention. The method of data transmission boosting shown in FIG. 2 can be achieved through the data transmission boosting device 1 shown in FIG. 1. As shown in FIG. 1, the data transmission boosting device 1 of this embodiment can be connected to a router 2 and the terminal devices 3A, 3B, and 3C, and can receive a plurality of data packets generated by the terminal devices 3A, 3B, and 3C. The router 2 is connected to a boosting server 4 (as shown in step Si). The data transmission boosting device 1 includes a classifying module 12 which storing a classifying model 121, and the classifying model 121 includes a plurality of classifying features. The classifying module 12 respectively classifies each of the data packets as one of data packet for boosting, non-boosting data packet and unknown data packet according to the classifying model 121 and a plurality of packet information of the data packets (as shown in step S2). The data transmission boosting device 1 transmits the data packets classified as the data packets for boosting to the boosting server 4 through the router 2 (as shown in step S31).

In practical applications, the terminal devices 3A, 3B, and 3C can be a computer, tablet, notebook, smart phone or a device for transmitting data through the network such as game console. When the terminal devices 3A, 3B, and 3C are the computers or smart phones and the users use the terminal devices 3A, 3B, and 3C to communication the network, the terminal devices 3A, 3B, and 3C generate a plurality of data packets. At this time, each data packet includes a plurality of packet information such as data, text, communication port, IP address and application layer domain feature string. In this embodiment, the data transmission boosting device 1 can include a data receiver or a data receiving module (not shown in the figure). The terminal devices 3A, 3B, and 3C can be connected to the receiver or data receiving module of the data transmission boosting device 1 by wire connection or wireless connection to transmit the data packets to the data transmission boosting device 1, wherein, the wireless connection can be WIFI, Zigbee, Bluetooth, UWB and NFC. Moreover, when the terminal devices 3A, 3B, and 3C are game consoles and the users use the terminal devices 3A, 3B, and 3C to play games, the terminal devices 3A, 3B, and 3C generate game data packets. In practical applications, the current game consoles may also have web browsing or download functions, so that the game consoles may also generate other types of data packets besides game data packets.

The connections between the devices are shown as solid line in the figures of the present invention, and the solid line represents the wire connection and wireless connection. In FIG. 1, the number of the terminal devices is three, but it is not a limitation. In practical applications, the number of the terminal devices can be one, two or more than three. At this time, the classifying module 12 of the data transmission boosting device 1 classifies the types of each data packets according to the classifying features of the classifying model 121 and the packet information of the data packets generated by the terminal devices 3A, 3B, and 3C. In practical applications, the classifying module 12 and the classifying model 121 can be an application program integrated in a calculating chip to calculate and classify the types of the data packets. In addition, the data transmission boosting device 1 can further include a storage (not shown in the figure) for storing the classifying features. The classifying feature can be a specific data such as a communication port data, game console number and IP address, IMEI of cell phone and feature string of application layer domain to classify the data packets. The classifying features can be preset in the classifying model 121, also can be stored in the classifying model 121 by the way of inputting or importing to provide the classifying module 12 to classify the types of the data packets. In this embodiment, the data transmission boosting device 1 transmits the data packets for boosting to the router 2 when the data packets generated by the terminal devices 3A, 3B, and 3C are classified as the data packets for boosting. Then, the router 2 transmits the data packets for boosting to the boosting server 4, as shown in step S31 of FIG. 2. Therefore, the data packets generated by the terminal devices 3A, 3B, and 3C are classified as the data packets for boosting by the classifying module 12 of the data transmission boosting device 1 and transmitted to the boosting server 4 to improve transmission efficient.

In one embodiment, the data packet for boosting is a game data packet. In practical applications, the classifying features of the classifying model 121 are the game data features of the game program, such as the IP address of the game console, the communication port of the game application program and so on. The gamers may run other programs or web pages in addition to the game program when playing online games. Therefore, the data packets generated by the terminal devices 3A, 3B, and 3C include game data packets and other types of data packets. The classifying module 12 of the data transmission boosting device 1 selects the game data packets matching to the game data features according to the packet information of the data packets and the game data features of the classifying model 121 after the data transmission boosting device 1 receives the data packets generated by the terminal devices 3A, 3B, and 3C. Then, the data transmission boosting device 1 transmits the game data packets to the boosting server 4 through the router 2. Therefore, the game data packets can be transmitted to the game server rapidly, and the gamers also can play online games smoothly.

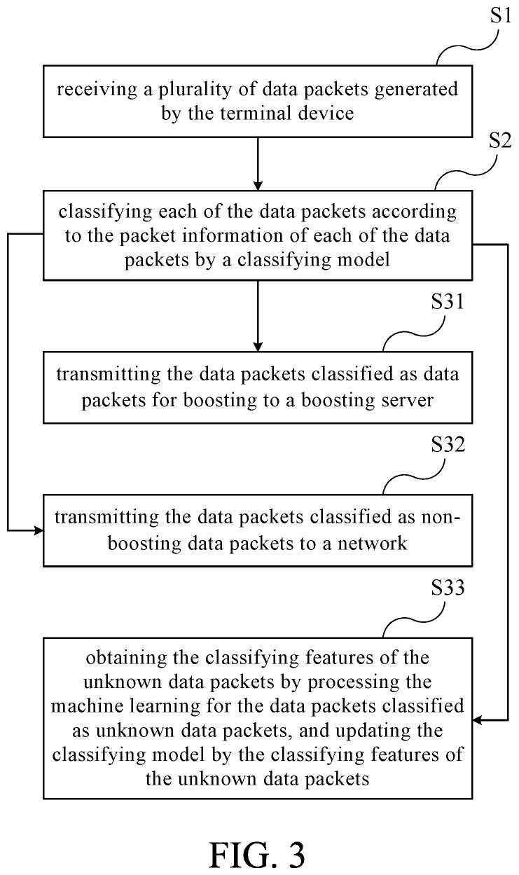

Please refer to FIG. 1 and FIG. 3. FIG. 3 is a flow chart diagram illustrating the method of data transmission boosting according to one embodiment of the present invention. The method of data transmission boosting shown in FIG. 3 can be achieved through the data transmission boosting device 1 shown in FIG. 1. In one embodiment, when the data packets generated by the terminal devices 3A, 3B, and 3C are classified as the non-boosting data packets, the data transmission boosting device 1 directly transmits the non-boosting data packets to the network rather the boosting server 4 through the router 2 (shown as step S32 in FIG. 3). In practical applications, the classifying model 121 include a first classifying feature and a second classifying feature, wherein, the first classifying feature includes the packet information of the data packet for boosting, and the second classifying feature includes the packet information of the non-boosting data packets. If the data packet for boosting is a game data packet, the second classifying feature would be the data information except the data information of the game data packet, such as web page data, advertisement data and so on. When the data transmission boosting device 1 receives the data packets generated by the terminal devices 3A, 3B, and 3C, the classifying module 12 of the data transmission boosting device 1 classifies the types of data packets according to the first classifying feature and the second classifying feature. If the classifying module 12 classifies the data packets as the game data packets, the data transmission boosting device 1 transmits the game data packets to the boosting server 4 through the router 2. If the classifying module 12 classifies the data packets as the non-boosting data packets, the data transmission boosting device 1 transmits the non-boosting data packets to the network 5 through the router 2. In this embodiment, the network 5 is the internet. The non-boosting data packets do not need to be transmitted to other terminal devices or servers instantaneously and quickly and the it would not affect the operations and requires of the user. Therefore, the classifying module 12 of the data transmission boosting device 1 can split flow for the data packets to reduce the network flow cost. In addition, the data packets will be classified as the unknown data packets if the data packets could not be classified according to the first classifying feature and the second classifying feature by the classifying module 12.

Please refer to FIG. 1 and FIG. 3 again. As shown in FIG. 1, the data transmission boosting device 1 further includes a learning module 13 connected to the classifying module 12. The learning module 13 analyzes the data packets classified as the unknown data packets by machine learning to obtain the classifying features of the unknown data packets, and transmits the classifying features back to the classifying module 12 to update the classifying model 121 (as shown in step S33 of FIG. 3). In practical applications, the learning module 13 can be integrated in a machine learning chip for analyzing the unknown data packets. In details, machine learning means that the learning module 13 learns according to the past data (such as the classifying feature preset in the classifying model by the manufacturer) and analyzes new information of the unknown data packets and predicts new classifying features through the past data (such as the classifying feature preset in the classifying model by the manufacturer). Then, the learning module 13 transmits the new classifying features back to the classifying model 121 to update the classifying model 121 to make the classifying model 121 include new classifying features to classify the unknown data packets.

When the data transmission boosting device 1 receives the unknown data packets generated by the terminal devices 3A, 3B, and 3C in the next time, the classifying module 12 can classify the unknown data packets as the data packets for boosting or the non-boosting data packets. Therefore, the data transmission boosting device 1 can increase or update the types of data packets classified by the classifying module 12 through the learning module 13.

The data packets are classified as the unknown data packets for the packet information of these data packets do not match all of the first classifying features and the second features. The unknown data packets merely mean that the current classifying module 12 is incapable of classifying these data packets, and the unknown data packets might be the data packets for boosting, such as those generated by new game consoles or new game programs. Because the machine learning procedure takes plenty of time and data packets, the unknown data packets are transmitted to the boosting server 4 before updating the classifying model 121 to prevent the situation that the data packets for boosting are not transmitted to the boosting server 4.

In another one embodiment, the data transmission boosting device 1 further includes a storage unit (not shown in the figure) or database for storing the unknown data packets. After classifying the data packets generated by the terminal devices 3A, 3B, and 3C as the unknown data packets, the classifying module 12 of the data transmission boosting device 1 copies the unknown data packets and stores the copies into the storage unit or database to provide the learning module 13 for machine learning, and the data transmission boosting device 1 transmits the original unknown data packets to the boosting server 4 through the router 2.

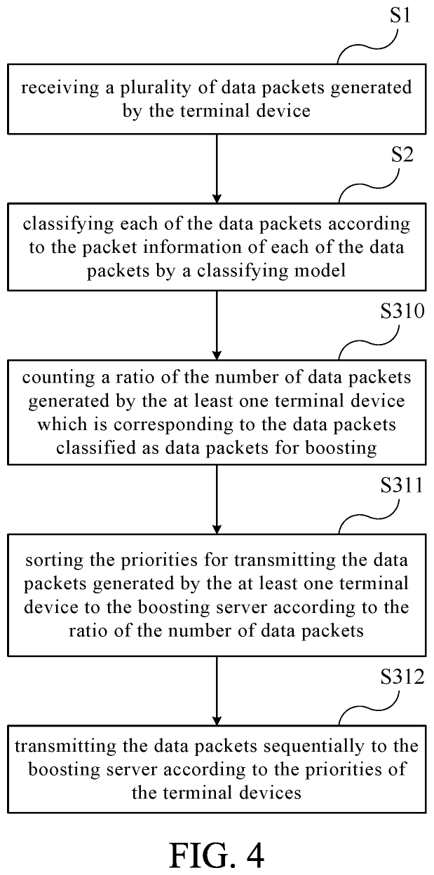

Please refer to FIG. 1 and FIG. 4. FIG. 4 is a step flow drawing illustrating the method of data transmission boosting according to one embodiment of the present invention. The method for boosting data transmission shown in FIG. 4 can be achieved through the data transmission boosting device 1 shown in FIG. 1. In this embodiment, the data transmission boosting device 1 further includes a sorting module 14 connected to the classifying module 12. The sorting module 14 counts a ratio of the number of the data packets generated by the terminal devices 3A, 3B, and 3C which are corresponding to the data packets classified as the data packets for boosting (as shown in step S310). Then, the sorting module 14 sorts the priorities for transmitting the data packets generated by the terminal devices 3A, 3B, and 3C to the boosting server 4 according to the ratio of the number of data packets. Finally, the data transmission boosting device 1 transmits the data packets generated by the terminal devices 3A, 3B, and 3C sequentially to the boosting server 4 according to the priorities of the terminal devices 3A, 3B, and 3C (as shown in step S312).

In practical applications, the sorting module 14 and the classifying module 12 can be integrated in the same calculating chip. The packet information of the data packets classified as the data packets for boosting include the device information of terminal devices 3A, 3B, and 3C such as IP address of computers, IMEI of cell phones, or include the packet information of different application programs in the same terminal devices 3A, 3B, and 3C. The sorting module 14 of the data transmission boosting device 1 can search and mark the terminal devices 3A, 3B, and 3C or application programs from the data packets for boosting according to the device information of the terminal devices 3A, 3B, and 3C or the packet information of the application programs. Then, the sorting module 14 sorts the priorities of terminal devices 3A, 3B, and 3C or application programs according to the number of data packets for boosting of different terminal devices 3A, 3B, and 3C or application programs in decreasing order. The data transmission boosting device 1 transmits the data packets for boosting to the boosting server 4 through the router 2 according to the priorities. It should be noticed that the number of the aforementioned data packets for boosting can be cumulated in a period of time or permanent. For example, if the user spends more time with the first game than the second game, the cumulative number of data packets of the first game are greater than those of the second game. That is to say, the ratio of the number of data packets of the first game to all the data packets for boosting is relatively high. Base on the aforementioned priorities, the data transmission boosting device 1 can boosts the commonly used terminal devices 3A, 3B, and 3C or application programs.

However, the sorting module 14 can also pre-store the priorities of the data packets in addition to sort the priorities by the aforementioned cumulative number of the data packets. For example, the sorting module 14 includes a priority boosting list, wherein, the priority boosting list can be set by the user or pre-stored by the manufacturer. When the data transmission boosting device 1 receives the data packets generated by the terminal devices 3A, 3B, and 3C, the sorting module 14 transmits the data packets to the boosting server 4 according to the priority boosting list.

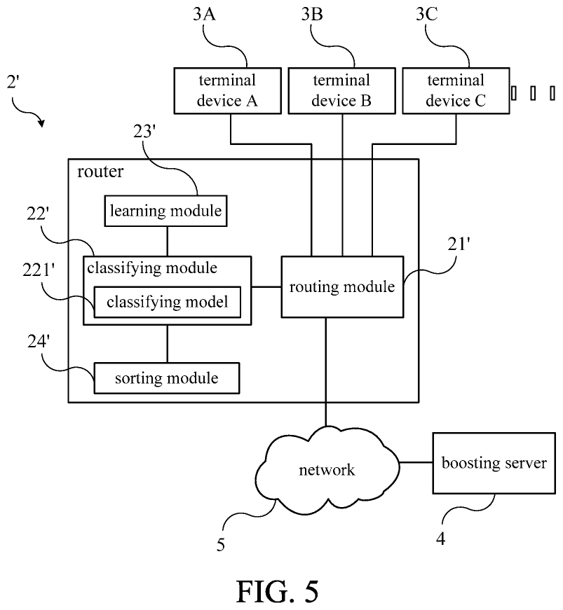

Please refer to FIG. 5. FIG. 5 is a functional block drawing illustrating the router 2′ according to one embodiment of the present invention. In one embodiment, the present invention provides a router 2′ including a routing module 21′ and a classifying module 22′. The routing module 21′ is connected to the terminal devices 3A, 3B, and 3C and receives a plurality of data packets generated by the terminal devices 3A, 3B, and 3C. The classifying module 22′ is connected to the routing module 21′ and stores a classifying model 221′, and the classifying model 221′ includes a plurality of classifying features. The classifying module 22′ classifies each of the data packets as one of data packet for boosting, non-boosting data packet and unknown data packet according to the classifying model 221′ and a plurality of packet information of the data packets. The router 2′ transmits the data packets classified as the data packets for boosting to the boosting server 4. In practical applications, the routing module 21′ can integrated in the CPU to control the router 2′ to receive or transmit the data packets. The functions of other component in this embodiment are the same as those in the prior embodiments, and they would not be described again. The data packets are classified as the data packets for boosting when the packet information of the data packets generated by the terminal devices 3A, 3B, and 3C match the classifying features in the classifying model 221′. At this time, the router 2′ transmits the data packets classified as the data packets for boosting to the boosting server 4. In one embodiment, the router 2′ transmits the data packets classified as non-boosting data packets to the network 5.

In this embodiment, the router 2′ further includes a learning module 23′ connected to the classifying module 22′. The learning module 23′ analyzes the data packets classified as the unknown data packets by machine learning to obtain the classifying features of the unknown data packets, and transmits the classifying features back to the classifying module 22′ to update the classifying model 221′. The function of the learning module 23′ of this embodiment is the same as those in the prior embodiments, and it would not be described again here.

In this embodiment, the route 2′ further includes a sorting module 24′ connected to the classifying module 22′. The sorting module 24′ counts a ratio of the number of data packets by the data packets generated by the terminal devices 3A, 3B, and 3C corresponding to the data packets classified as the data packets for boosting, and sorts the priorities for transmitting the data packets generated by the terminal devices 3A, 3B, and 3C to the boosting server 4 according to the ratio of the number of data packets. The function of the sorting module 24′ of this embodiment is the same as those in the prior embodiments, and it would not be described again here.

In summary, the data transmission boosting device or the router of the present invention classifies whether the data packets generated by the terminal device are the data packets for boosting by the classifying module, and arranges the priorities to transmit the data packets for boosting to the boosting server by the sorting module according to the ratio of the number of the data packets. The data transmission boosting device not only can improve the transmission efficient, but also can save the network flow cost.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A data transmission boosting device for connecting a router and at least one terminal device, and receiving a plurality of data packets generated by the terminal device, the router being connected to a boosting server through a network, the data transmission boosting device comprising:
a classifying module storing a classifying model, the classifying model comprising a plurality of classifying features, and the classifying module classifying each of the data packets as one of data packet for boosting, non-boosting data packet and unknown data packet according to the classifying model and a plurality of packet information of the data packets;
wherein, the data transmission boosting device transmits the data packets classified as the data packets for boosting to the boosting server through the router.

2. The data transmission boosting device of claim 1, wherein the data packet for boosting is a game data packet.

3. The data transmission boosting device of claim 1, wherein the data transmission boosting device transmits the data packets classified as the non-boosting data packets to the network.

4. The data transmission boosting device of claim 1, further comprising a learning module connected to the classifying module, the learning module analyzing the data packets classified as the unknown data packets by machine learning to obtain the classifying features of the unknown data packets, and transmitting the classifying features back to the classifying module to update the classifying model.

5. The data transmission boosting device of claim 1, further comprising a sorting module connected to the classifying module, the sorting module counting a ratio of the number of data packets generated by the at least one terminal device which is corresponding to the data packets classified as the data packets for boosting, and sorting the priorities for transmitting the data packets generated by the at least one terminal device to the boosting server according to the ratio of the number of data packets.

6. A method for boosting a data transmission comprising the following steps of:
receiving a plurality of data packets generated by at least one terminal device;
classifying each of the data packets as one of data packet for boosting, non-boosting data packet and unknown data packet according to a packet information of each of the data packets by a classifying model respectively, and the classifying model comprising a plurality of classifying features; and
transmitting the data packets classified as the data packets for boosting to a boosting server.

7. The method of claim 6, further comprising the following step of:
transmitting the data packets classified as the non-boosting data packets to a network.

8. The method of claim 6, further comprising the following step of:
obtaining the classifying features of the unknown data packets by machine learning for the data packets classified as the unknown data packets, and updating the classifying model by the classifying features of the unknown data packets.

9. The method of claim 6, further comprising the following steps of:
counting a ratio of the number of data packets generated by the at least one terminal device which is corresponding to the data packets classified as the data packets for boosting; and
sorting the priorities for transmitting the data packets generated by the at least one terminal device to the boosting server according to the ratio of the number of data packets.

10. A router, comprising:
a routing module connected to at least one terminal device and a boosting server, and receiving a plurality of data packets generated by the at least one terminal device; and
a classifying module connected to the routing module and storing a classifying model, the classifying model comprising a plurality of classifying features, and the classifying module classifying each of the data packets as one of data packet for boosting, non-boosting data packet and unknown data packet according to the classifying model and a plurality of packet information of the data packets;
wherein, the router transmits the data packets classified as the data packets for boosting to the boosting server.

11. The router of claim 10, wherein the data packet for boosting is a game data packet.

12. The router of claim 10, wherein the router transmits the data packets classified as the non-boosting data packets to a network.

13. The router of claim 10, further comprising a learning module connected to the classifying module, the learning module analyzing the data packets classified as the unknown data packets by machine learning to obtain the classifying features of the unknown data packets, and transmitting the classifying features back to the classifying module to update the classifying model.

14. The router of claim 10, further comprising a sorting module connected to the classifying module, the sorting module counting a ratio of the number of data packets by the data packets generated by the at least one terminal device which is corresponding to the data packets classified as the data packets for boosting, and sorting the priorities for transmitting the data packets generated by the at least one terminal device to the boosting server according to the ratio of the number of data packets.
